(19) United States
(12) Patent Application Publication
(10) Pub. No.: US 2025/0247896 A1
(43) Pub. Date: Jul. 31, 2025

(54) RANDOM ACCESS PROCEDURE BASED ON ENERGY HARVESTING CLASS

(71) Applicant: QUALCOMM Incorporated, San Diego, CA (US)

(72) Inventors: Linhai HE, San Diego, CA (US); Wanshi CHEN, San Diego, CA (US); Jing LEI, San Diego, CA (US); Ahmed ELSHAFIE, San Diego, CA (US); Seyedkianoush HOSSEINI, San Diego, CA (US); Huilin XU, Temecula, CA (US); Yuchul KIM, San Diego, CA (US); Zhikun WU, Beijing (CN)

(21) Appl. No.: 18/854,284

(22) PCT Filed: Jun. 2, 2022
(86) PCT No.: PCT/CN2022/096775

§ 371 Date: Oct. 4, 2024

(51) Int. Cl. H04W 74/0836; H02J 50/00; H04W 24/08; H04W 74/00

(52) U.S. Cl. CPC H04W 74/0836; H02J 50/001; H04W 24/08; H04W 74/006

(57) ABSTRACT

Various aspects of the present disclosure generally relate to wireless communication. In some aspects, a user equipment (UE) may receive configuration information that includes parameters associated with multiple energy harvesting (EH) classes. The UE may select an EH class, from among the multiple EH classes, based at least in part on the configuration information and an EH state of the UE. The UE may perform a 2-step random access channel (RACH) procedure based at least in part on the EH class. Numerous other aspects are described.

### FIELD OF THE DISCLOSURE

Aspects of the present disclosure generally relate to wireless communication and to techniques and apparatuses for performing a random access procedure based on an energy harvesting class.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information that includes parameters associated with multiple energy harvesting (EH) classes. The method may include selecting an EH class, from among the multiple EH classes, based at least in part on the configuration information and an EH state of the UE. The method may include performing a 2-step random access channel (RACH) procedure based at least in part on the EH class.

Some aspects described herein relate to a method of wireless communication performed by a network entity. The method may include transmitting configuration information that includes parameters associated with multiple EH classes. The method may include receiving an indication of an EH class that is selected by a UE. The method may include performing a 2-step RACH procedure with the UE based at least in part on the EH class.

Some aspects described herein relate to a UE for wireless communication. The UE may include a memory and one or more processors coupled to the memory. The one or more processors may be configured to receive configuration information that includes parameters associated with multiple EH classes. The one or more processors may be configured to select an EH class, from among the multiple EH classes, based at least in part on the configuration information and an EH state of the UE. The one or more processors may be configured to perform a 2-step RACH procedure based at least in part on the EH class.

Some aspects described herein relate to a network entity for wireless communication. The network entity may include a memory and one or more processors coupled to the memory. The one or more processors may be configured to transmit configuration information that includes parameters associated with multiple EH classes. The one or more processors may be configured to receive an indication of an EH class that is selected by a UE. The one or more processors may be configured to perform a 2-step RACH procedure with the UE based at least in part on the EH class.

Some aspects described herein relate to a non-transitory computer-readable medium that stores a set of instructions for wireless communication by a UE. The set of instructions, when executed by one or more processors of the UE, may cause the UE to receive configuration information that includes parameters associated with multiple EH classes. The set of instructions, when executed by one or more processors of the UE, may cause the UE to select an EH class, from among the multiple EH classes, based at least in part on the configuration information and an EH state of the UE. The set of instructions, when executed by one or more processors of the UE, may cause the UE to perform a 2-step RACH procedure based at least in part on the EH class.

Some aspects described herein relate to a non-transitory computer-readable medium that stores a set of instructions for wireless communication by a network entity. The set of instructions, when executed by one or more processors of the network entity, may cause the network entity to transmit configuration information that includes parameters associated with multiple EH classes. The set of instructions, when executed by one or more processors of the network entity, may cause the network entity to receive an indication of an EH class that is selected by a UE. The set of instructions, when executed by one or more processors of the network entity, may cause the network entity to perform a 2-step RACH procedure with the UE based at least in part on the EH class.

Some aspects described herein relate to an apparatus for wireless communication. The apparatus may include means for receiving configuration information that includes parameters associated with multiple EH classes. The apparatus may include means for selecting an EH class, from among the multiple EH classes, based at least in part on the configuration information and an EH state of the apparatus. The apparatus may include means for performing a 2-step RACH procedure based at least in part on the EH class.

Some aspects described herein relate to an apparatus for wireless communication. The apparatus may include means for transmitting configuration information that includes parameters associated with multiple EH classes. The apparatus may include means for receiving an indication of an EH class that is selected by another apparatus. The apparatus may include means for performing a 2-step RACH procedure with the other apparatus based at least in part on the EH class.

Aspects generally include a method, apparatus, system, computer program product, non-transitory computer-readable medium, UE, wireless device, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of energy harvesting (EH), in accordance with the present disclosure.

FIG. 5 is a diagram illustrating an example of a 2-step random access channel (RACH) procedure, in accordance with the present disclosure.

FIG. 6 is a diagram illustrating an example associated with a RACH procedure that is based on an EH class, in accordance with the present disclosure.

FIG. 7 is a diagram illustrating an example 700 of timing parameters, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

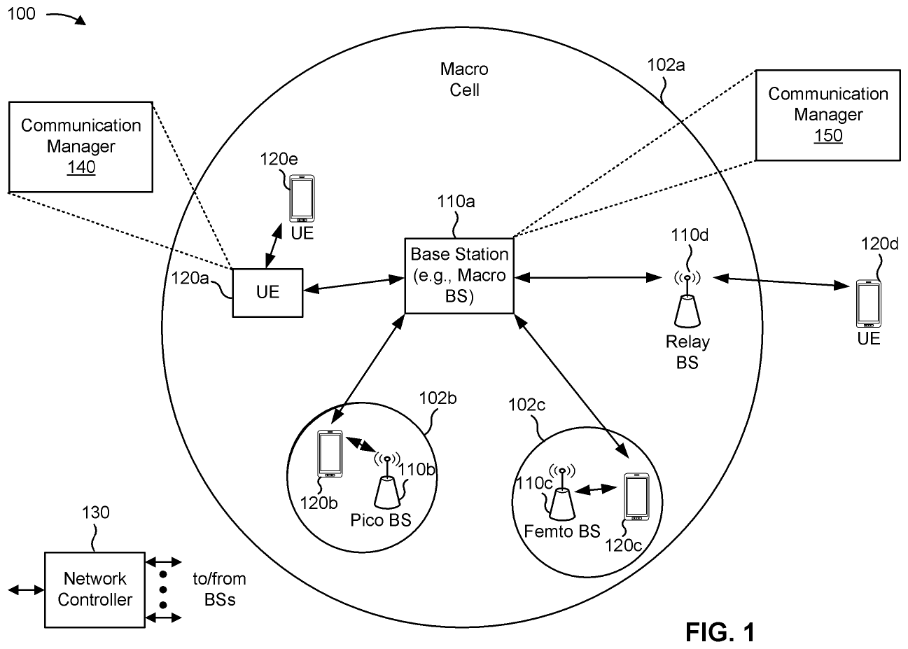

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a IoT device, a zero power device, a UE 120) may include a communication manager 140. As described in more detail elsewhere herein, the communication manager 140 may receive configuration information that includes parameters associated with multiple energy harvesting (EH) classes. The communication manager 140 may select an EH class, from among the multiple EH classes, based at least in part on the configuration information and an EH state of the UE. The communication manager 140 may perform a 2-step random access channel (RACH) procedure based at least in part on the EH class. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit configuration information that includes parameters associated with multiple EH classes. The communication manager 150 may receive an indication of an EH class that is selected by a UE and perform a 2-step RACH procedure with the UE based at least in part on the EH class. Additionally, or alternatively, the communication manager 150 may perform one or more other operations described herein.

As indicated above, FIG. 1 is provided as an example. Other examples may differ from what is described with regard to FIG. 1.

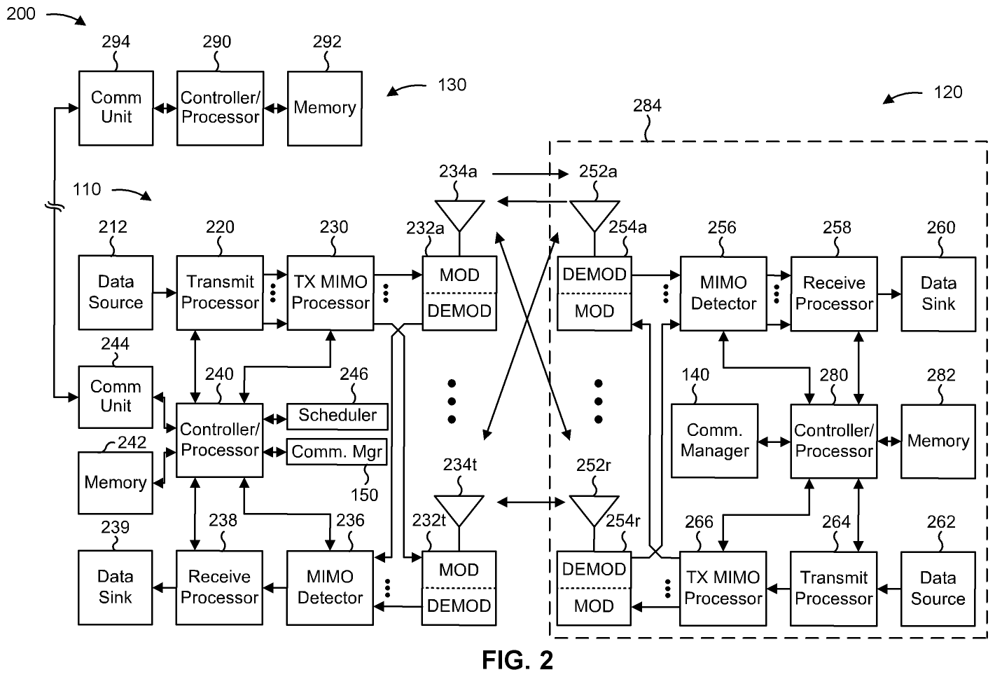

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

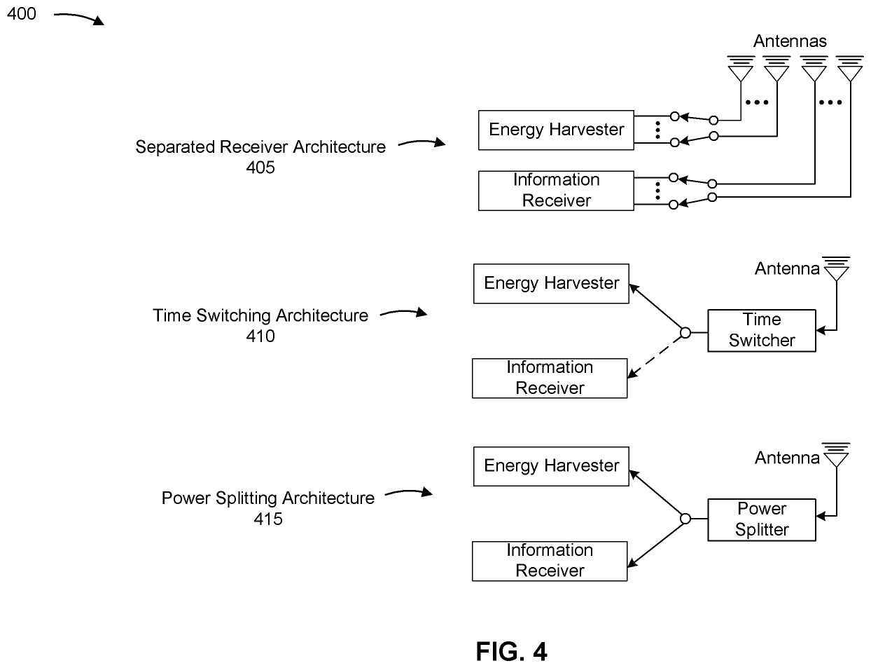

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

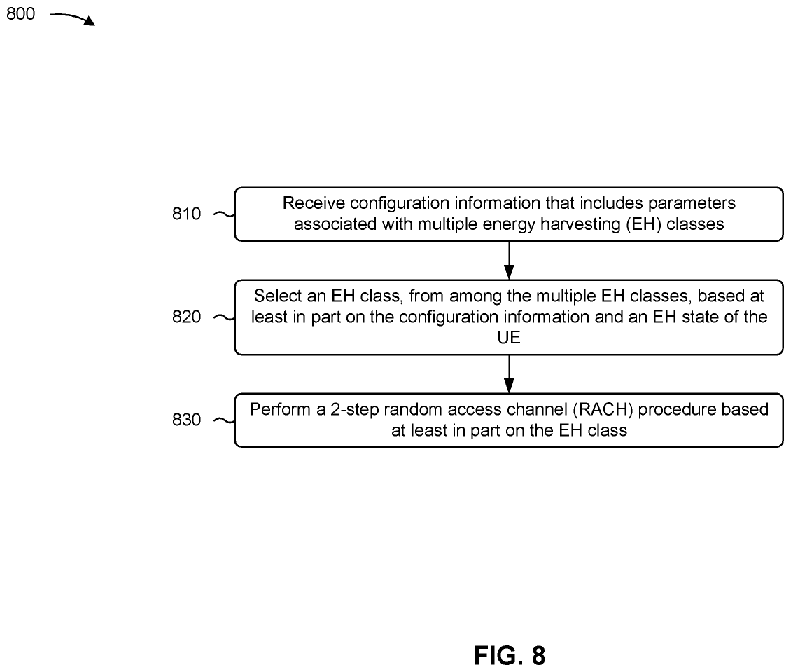

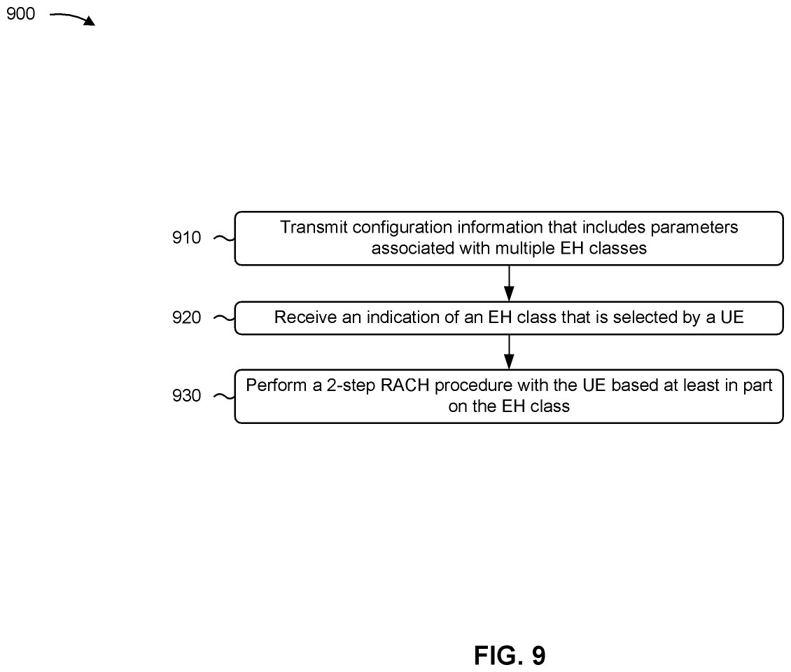

A controller/processor of a network entity (e.g., the controller/processor 240 of the base station 110), the controller/processor 280 of the UE 120, and/or any other component(s) of FIG. 2 may perform one or more techniques associated with performing a random access procedure based on an EH class, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., an IoT device, a zero power device, a UE 120) includes means for receiving configuration information that includes parameters associated with multiple EH classes; means for selecting an EH class, from among the multiple EH classes, based at least in part on the configuration information and an EH state of the UE; and/or means for performing a 2-step RACH procedure based at least in part on the EH class. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a base station 110, a charging device) includes means for transmitting configuration information that includes parameters associated with multiple EH classes; means for receiving an indication of an EH class that is selected by a UE; and means for performing a 2-step RACH procedure with the UE based at least in part on the EH class. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

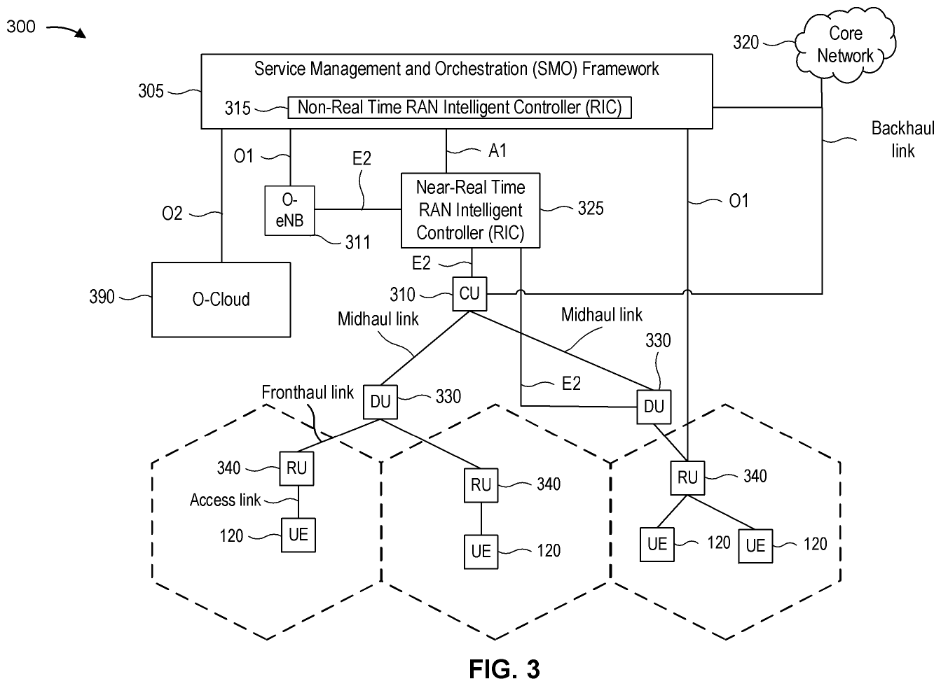

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of energy harvesting, in accordance with the present disclosure.

Energy harvesting includes a device obtaining energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, IoT devices, wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 4, an RF receiver (e.g., a UE 120) may receive signals (e.g., radio signals carried on radio waves) from an RF transmitter (e.g., a base station 110 or UE 120) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 405, in some aspects, the RF receiver may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 410, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components to harvest energy, and one or more second time slots may be time slots during which received signals are processed and decoded to receive information. In some aspects, the time slots may be pre-configured (e.g., by the RF receiver, the RF transmitter, or another device).

As shown by reference number 415, in some aspects, the RF receiver may use a power splitting architecture to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. The energy harvesting mode for a device may be semi-statistically configured by RRC messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal but not perform other communications. The energy harvesting device may have a main radio that is configured to perform communications and that consumes more power than the low-power radio or wake-up radio.

Energy harvesting devices, more generally, may rely equally or differently on different energy harvesting techniques such as solar power, vibration, thermal energy, or RF energy harvesting. Energy harvesting can be predictable or unpredictable due to the energy being intermittently available.

The energy harvesting (EH) device may have limited EH capabilities, energy storage capabilities, and/or RF capabilities depending on a class of the EH device. Different classes of EH devices may have different capabilities. For example, some IoT devices or sensors may have different capabilities than smart wearables (e.g., exercise monitors, medical monitoring devices, gaming device sensors). Some EH classes may have a mandatory set of features and an optional set of features.

As indicated above, FIG. 4 is provided as an example. Other examples may differ from what is described with regard to FIG. 4.

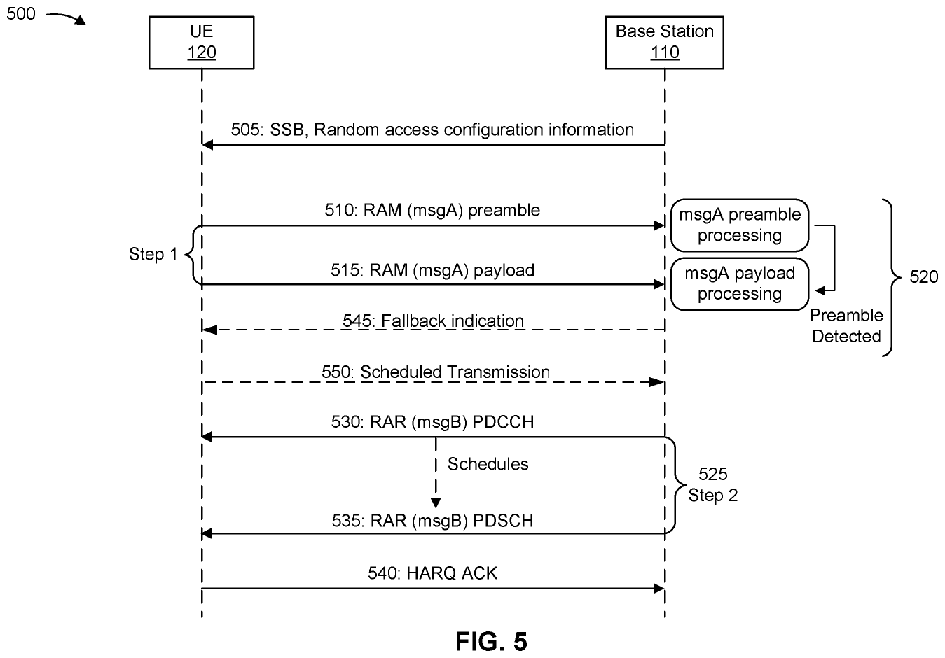

FIG. 5 is a diagram illustrating an example 500 of a two-step (2-step) RACH procedure, in accordance with the present disclosure. As shown in FIG. 5, a network entity (e.g., base station 110) and a UE 120 may communicate with one another to perform the 2-step RACH procedure.

As shown by reference number 505, the base station 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the 2-step RACH procedure, such as one or more parameters for transmitting a random access message (RAM) and/or receiving a random access response (RAR) to the RAM.

As shown by reference number 510, the UE 120 may transmit, and the base station 110 may receive, a RAM preamble. As shown by reference number 515, the UE 120 may transmit, and the base station 110 may receive, a RAM payload. As shown, the UE 120 may transmit the RAM preamble and the RAM payload to the base station 110 as part of an initial (or first) step of the 2-step RACH procedure. In some aspects, the RAM may be referred to as message A, msgA, a first message, or an initial message in a 2-step RACH procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step RACH procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

As shown by reference number 520, the base station 110 may receive the RAM preamble transmitted by the UE 120. If the base station 110 successfully receives and decodes the RAM preamble, the base station 110 may then receive and decode the RAM payload.

As shown by reference number 525, the base station 110 may transmit an RAR (sometimes referred to as an RAR message). As shown, the base station 110 may transmit the RAR message as part of a second step of the 2-step RACH procedure. In some aspects, the RAR message may be referred to as message B, msgB, or a second message in a 2-step RACH procedure. The RAR message may include some or all of the contents of message 2 (msg2) and message 4 (msg4) of a four-step (4-step) RACH procedure. For example, the RAR message may include the detected PRACH preamble identifier, the detected UE identifier, a timing advance value, and/or contention resolution information.

As shown by reference number 530, as part of the second step of the 2-step RACH procedure, the base station 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 535, as part of the second step of the 2-step RACH procedure, the base station 110 may transmit the PDSCH communication for the RAR, as scheduled by the PDCCH communication. The RAR may be included in a medium access control (MAC) protocol data unit (PDU) of the PDSCH communication. As shown by reference number 540, if the UE 120 successfully receives the RAR, the UE 120 may transmit a hybrid automatic repeat request (HARQ) acknowledgement (ACK).

In some scenarios, the base station 110 may fall back from the 2-step RACH procedure to a 4-step RACH procedure after a transmission failure of the 2-step RACH procedure. For example, if the base station 110 successfully detects a PRACH preamble but fails to decode a PUSCH communication, the base station 110 may switch to a 4-step RACH procedure. This may include transmitting a fallback indication, as shown by reference number 545. The fallback indication may schedule a transmission for the UE 120. As shown by reference number 550, the UE 120 may transmit the scheduled transmission.

However, the UE 120 may not have a full amount of energy to perform the entire RACH procedure in a single active duration. In fact, the amount of energy that the UE 120 is able to harvest may be random and unpredictable. Furthermore, UEs may have different EH capabilities and may require different RACH configurations. If the UE 120 is not able to complete a RACH procedure, communications may fail and latency may increase.

As indicated above, FIG. 5 is provided as an example. Other examples may differ from what is described with regard to FIG. 5.

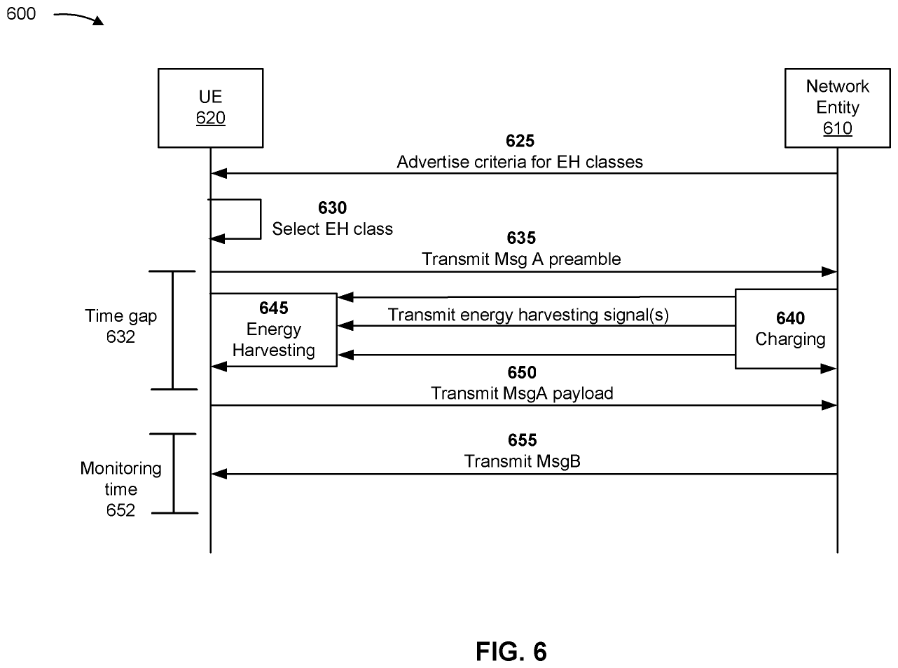

FIG. 6 is a diagram illustrating an example 600 associated with a RACH procedure that is based on an EH class, in accordance with the present disclosure. As shown in FIG. 6, a UE 620 (e.g., an IoT, a zero power device, a UE 120) may harvest energy from a network entity 610 (e.g., a base station 110). The network entity 610 may operate as a charging device or another device may operate as the charging device for the UE 120.

According to various aspects described herein, there may be multiple EH classes for a 2-step RACH procedure, where each EH class is targeted to devices with different EH capabilities (e.g., maximum duty cycle supported during a RACH procedure). Each EH class may be configured with different RACH resources and parameters (RACH parameters). The network entity 610 may advertise, in system information, a supported set of EH classes and the parameters associated with each class. The network entity 610 may transmit configuration information that specifies the RACH resources and/or the parameters.

The UE 620 may select an EH class based at least in part on an EH state of the UE 620 and the configuration information. The EH state may include a current amount of energy stored at the UE 620 and/or a capability of the UE 620 to harvest more energy. The UE 620 may perform a 2-step RACH procedure based at least in part on the EH class. This may include transmitting an indication of the selected EH class or an indication of a preferred EH class in the MsgA payload of the 2-step RACH procedure. In some aspects, the UE 620 may select between a 2-step RACH procedure and a 4-step RACH procedure based at least in part on an EH state of the UE 620. The UE 620 may also use an RSRP of downlink reference signals to select a RACH procedure. For example, the network entity 610 may configure the RSRP thresholds so as to give the UE 620 more of an opportunity to use a 2-step RACH procedure rather than a 4-step RACH procedure.

In some aspects, the configuration information may include parameters associated with multiple EH classes. Such parameters may include a maximum duty cycle that can be supported during the RACH procedure, a RACH resource, a RACH parameter, a PRACH preamble set, a quantity of PRACH occasions, a periodicity of PRACH occasions, PRACH occasions dedicated to each EH class for MsgA preamble, and/or a minimum amount of energy that is required at a start of the 2-step RACH procedure. The parameters may also include a quantity of RACH attempts that can be performed without harvesting more energy, a capability of the UE 620 to ensure that the UE 620 will have a sufficient amount of energy to finish the 2-step RACH procedure, a minimum EH rate, and/or a parameter of the EH class that includes a quantity of RAR windows. The parameters may include timing parameters, such as a time duration or a time gap between transmitting a MsgA preamble and transmitting a MsgA payload, a time gap between performing a measurement and transmitting a MsgA, a time gap between transmitting a MsgA and monitoring for a MsgB, and/or a time gap between two RAR windows.

By selecting an EH class based at least in part on the EH state and the configuration, the UE 620 may ensure that there is sufficient energy to complete a RACH procedure. As a result, the UE 620 may limit connection failures and avoid increases in latency.

Example 600 shows how the UE 620 and/or the network entity 610 can ensure that the UE 620 has enough energy to complete at least one RACH attempt. Some devices are able to complete a RACH attempt without harvesting extra energy during the RACH procedure. Other devices will need to harvest energy during the RACH procedure.

As shown by reference number 625, the network entity 610 may advertise access criteria for EH classes. This may include transmitting configuration information that includes parameters associated with multiple EH classes. For example, one criterion for EH class k is the amount of energy the LIE 620 needs to have at a start of a RACH procedure. This amount may be, for example, greater than or equal to Xₖ %×Emin. Emin may be the minimum amount of energy required to complete one RACH attempt. Note that network entity 610 advertises Xₖ but does not need to advertise the actual value of Emin, which may vary across different device implementations. The network entity 610 may also advertise or configure Enominal, which may be the expected number of RACH attempts that the device can perform without harvesting. Therefore, if Enominal is configured, the amount of energy that UE 620 needs to have at start of RACH procedure is greater than or equal to Xk %×Emin×Enominal.

In some aspects, a criterion may be an EH rate of a device. For example, if Xₖ<100%, then the UE 620 may need to be certain (e.g., with 90% of certainty) that the UE 620 can harvest energy fast enough to finish a RACH procedure without early termination (due to a power outage). The network entity 610 may also advertise a minimum EH rate (EHₖ) for a device to use EH class k. EHₖ can be expressed as fₖ %, such that fₖ %×Emin is the minimum amount of energy a device has to harvest in a slot.

As shown by reference number 630, the UE 620 may select an EH class based at least in part on the configuration information and an EH state of the UE 620. In this example, while the UE 620 has a limited amount of energy, the UE 620 is capable of harvesting energy during the 2-step RACH procedure. For example, the UE 620 may select an EH class that provides for a time gap 632 (e.g., T1) between a MsgA preamble and a MsgA payload of step 1 of the 2-step RACH procedure. As shown by reference number 635, the UE 620 may transmit the MsgA preamble but not yet transmit the MsgA payload. The UE 620 may enter an EH state where the UE 620 can harvest energy from RF signals. As shown by reference number 640, the network entity 610 may transmit signals to (charge) the UE 620. Alternatively, another device may charge the UE 620. As shown by reference number 645, the UE 620 may harvest the energy from the signals and store the energy in an energy storage device (e.g., a battery). The UE 620 may be in a sleep state during energy harvesting. The UE 620 may harvest a threshold amount of energy in order to proceed with transmitting the MsgA payload within the configured time gap 632.

As shown by reference number 650, the UE 620, having harvested a sufficient amount of energy, may transmit the MsgA payload. The MsgA payload may include an indication of the selected EH class. When the network entity 610 receives the indication of the selected EH class, the network entity 610 may perform the 2-step RACH procedure based at least in part on the selected EH class. In some aspects, the UE 620 may suggest a preferred EH class, and the network entity 610 may determine whether to use the preferred EH class.

If the UE 620 does not have sufficient energy to transmit the MsgA payload, the UE 620 may monitor for a fallback RAR. In response to receiving a fallback RAR, the UE 620 may transmit a Msg3 of a 4-step RACH procedure. The UE 620 may transmit the Msg3 in an uplink grant addressed to a cell radio network temporary identifier (C-RNTI) for the UE 620. The Msg3 may include an indication of when the UE 620 is able to monitor for a Msg4 of the 4-2 step RACH procedure. The network entity 610 may transmit the Msg4 based at least in part on the indication, or when the UE 620 is able to monitor for the Msg4.

In some aspects, if the UE 620 does not have energy to transmit a Msg3 at a PUSCH resource provided by the network entity 610 or no MsgB is received in any RAR window, the UE 620 may terminate the current RACH attempt and retransmit the MsgA. To retransmit the MsgA, the UE 620 may be allowed to accumulate enough energy and/or change its EH class.

In some aspects, the UE 620 may transmit another MsgA in response to not having a sufficient amount of energy to complete the 2-step RACH procedure and after harvesting energy to transmit the other MsgA. The UE 620 may select a new EH class before transmitting the other MsgA, where the other MsgA includes an indication of the new EH class.

The MsgA payload may also include an indication of a time gap for monitoring for the MsgB. In some aspects, after transmitting the MsgA, the UE 620 may select one or more RAR windows in which to monitor for a MsgB, based at least in part on an EH state of the UE.

After transmitting the MsgA, the UE 620 may terminate the 2-step RACH procedure, independently of an EH state of the UE 620, in response to receiving an uplink grant addressed to an RNTI of the UE, such as a C-RNTI, in an RAR window.

In some aspects, the configuration information may specify, for the selected EH class, a monitoring time 652. The monitoring time 652 may include, for example, an earliest slot in which the UE 620 is able to monitor for the MsgB. The monitoring time 652 may be a time gap (e.g., T2) after an end of a last uplink transmission. The UE 620 may transmit an indication of the earliest slot in a message, such as a MAC control element (MAC CE) that has a highest logical channel prioritization (LCP) priority, or at least a higher LCP priority than other MAC CEs.

As shown by reference number 655, the network entity 610 may transmit a MsgB. The UE 620 may receive the MsgB when the UE 620 is able to monitor for the MsgB, such as during the monitoring time 652. If the MsgB is successfully received, the UE 620 may terminate the 2-step RACH. This may involve transmitting an ACK for the MsgB.

In some aspects, the network entity 610 may configure separate RACH resources for different EH classes. If the network entity 610 does not configure separate RACH resources for the different EH classes, the UE 620 may indicate a preferred EH class in a MAC CE in a PUSCH payload. This indication may be in addition to a preferred time for MsgB such that the indication can be used if the UE 620 falls back to a 4-step RACH procedure. If the UE 620 does not have enough energy to transmit the PUSCH payload, the UE 620 may still proceed to monitor for a fallback RAR (if there is enough energy for reception).

As indicated above, FIG. 6 is provided as an example. Other examples may differ from what is described with respect to FIG. 6.

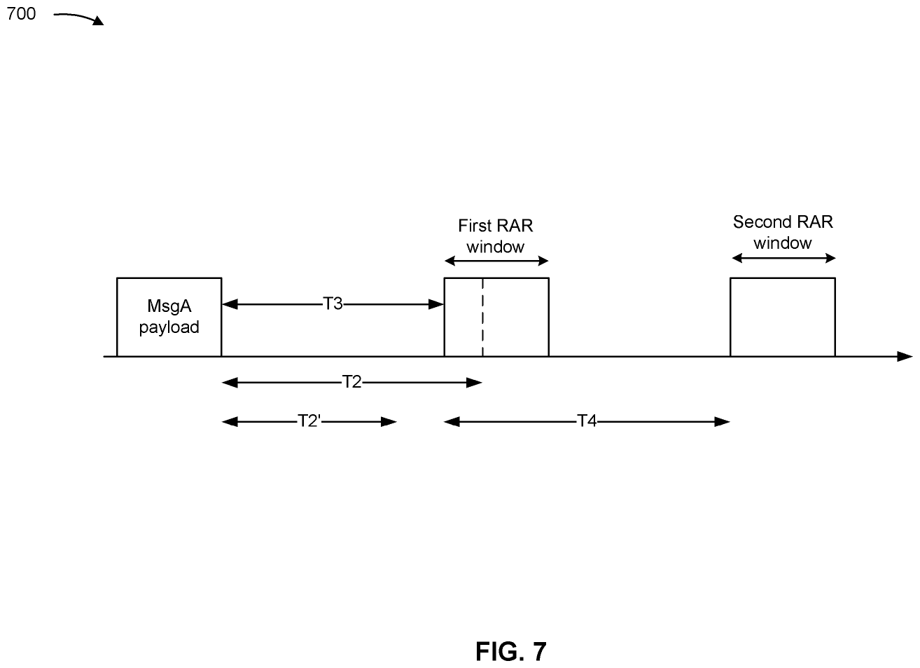

FIG. 7 is a diagram illustrating an example 700 of timing parameters, in accordance with the present disclosure.

In some aspects, the configuration information may include timing parameters, such as T1, T2, T3, T4, and N1. T1 may indicate a time duration, or time gap, between transmission of a MsgA preamble and transmission of a MsgA payload of step 1 of a 2-step RACH procedure. The start and end times for T1 or other timing parameters may be a start of a transmission or RAR window, a middle of a transmission or RAR window, or an end of a transmission or RAR window. T2 may indicate a time gap between an end of a last uplink transmission (e.g., MsgA payload) and when the UE 620 is to start monitoring for a MsgB. The UE 620 may transmit an indication of T2 in the MsgA payload. If T2 is longer than the start of the first RAR window, the UE 620 may start monitoring for MsgB from T2 if T2 ends inside the first RAR window or start monitoring at the start of the RAR window that follows the end of T2. If T2 is shorter than the start of the first RAR window, the UE 620 may start monitoring for MsgB at the first RAR window. If the UE 620 did not transmit the indication of T2 in the MsgA payload, the UE 620 may start monitoring for MsgB at the first RAR window.

T3 may indicate a time gap between the end of the MsgA payload and the start of the next RAR window. T4 may be a time gap between two consecutive RAR windows (e.g., between a start of each RAR window). The UE 620 may transmit preferred timing parameters in a MAC CE. The MAC CE may also include the preferred EH class. Another timing parameter may be a time gap between the UE 620 performing a measurement and transmitting the MsgA payload.

The UE 620 may not monitor for the MsgB in all of the RAR windows, in order to conserve power. N1 may indicate a quantity of RAR windows for MsgB reception. The UE 620 may transmit an indication of N1 in the MsgA payload and monitor for MsgB in RAR windows according to N1. Accordingly, the network entity 610 may transmit the MsgB in an RAR based at least in part on T4 and/or N1.

By indicating timing parameters for monitoring for MsgB, the UE 620 may limit how much energy is consumed monitoring for the MsgB. The network entity 610 or the UE 620 may also select the timing parameters such that the UE 620 is able to harvest energy before monitoring for the MsgB.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120, UE 620) performs operations associated with a RACH procedure based on EH class.

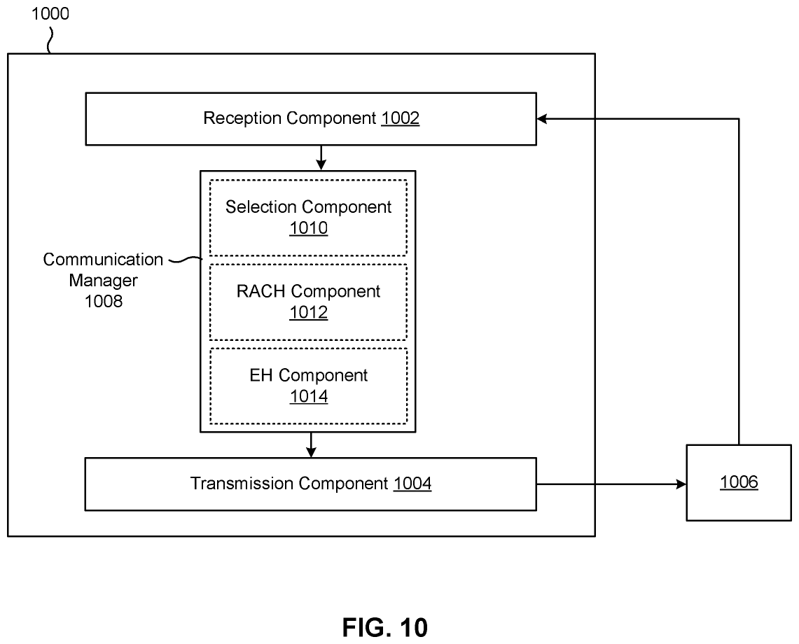

As shown in FIG. 8, in some aspects, process 800 may include receiving configuration information that includes parameters associated with multiple EH classes (block 810). For example, the UE (e.g., using communication manager 1008 and/or reception component 1002 depicted in FIG. 10) may receive configuration information that includes parameters associated with multiple EH classes, as described above.

As further shown in FIG. 8, in some aspects, process 800 may include selecting an EH class, from among the multiple EH classes, based at least in part on the configuration information and an EH state of the UE (block 820). For example, the UE (e.g., using communication manager 1008 and/or selection component 1010 depicted in FIG. 10) may select an EH class, from among the multiple EH classes, based at least in part on the configuration information and an EH state of the UE, as described above.

As further shown in FIG. 8, in some aspects, process 800 may include performing a 2-step RACH procedure based at least in part on the EH class (block 830). For example, the UE (e.g., using communication manager 1008 and/or RACH component 1012 depicted in FIG. 10) may perform a 2-step RACH procedure based at least in part on the EH class, as described above.

Process 800 may include additional aspects, such as any single aspect or any combination of aspects described below and/or in connection with one or more other processes described elsewhere herein.

In a first aspect, performing the 2-step RACH procedure includes transmitting an indication of the EH class in a MsgA payload.

In a second aspect, alone or in combination with the first aspect, a parameter associated with the EH class includes a maximum duty cycle that can be supported during the RACH procedure.

In a third aspect, alone or in combination with one or more of the first and second aspects, a parameter associated with the EH class includes a RACH resource or a RACH parameter.

In a fourth aspect, alone or in combination with one or more of the first through third aspects, a parameter associated with the EH class includes one or more of a PRACH preamble set, a quantity of PRACH occasions, or a periodicity of PRACH occasions.

In a fifth aspect, alone or in combination with one or more of the first through fourth aspects, a parameter associated with the EH class includes a minimum amount of energy that is required at a start of the 2-step RACH procedure.

In a sixth aspect, alone or in combination with one or more of the first through fifth aspects, process 800 includes harvesting energy during the 2-step RACH procedure.

In a seventh aspect, alone or in combination with one or more of the first through sixth aspects, a parameter associated with the EH class includes a quantity of RACH attempts that can be performed without harvesting more energy.

In an eighth aspect, alone or in combination with one or more of the first through seventh aspects, a parameter associated with the EH class includes a capability of the UE to ensure that the UE will have a sufficient amount of energy to finish the 2-step RACH procedure.

In a ninth aspect, alone or in combination with one or more of the first through eighth aspects, a parameter associated with the EH class includes a minimum EH rate.

In a tenth aspect, alone or in combination with one or more of the first through ninth aspects, a parameter associated with the EH class includes a time gap between transmitting a MsgA preamble and transmitting a MsgA payload.

In an eleventh aspect, alone or in combination with one or more of the first through tenth aspects, a parameter associated with the EH class includes a time gap between performing a measurement and transmitting a MsgA.

In a twelfth aspect, alone or in combination with one or more of the first through eleventh aspects, a parameter associated with the EH class includes a time gap between transmitting a MsgA and monitoring for a MsgB.

In a thirteenth aspect, alone or in combination with one or more of the first through twelfth aspects, process 800 includes transmitting an indication of the time gap in the MsgA.

In a fourteenth aspect, alone or in combination with one or more of the first through thirteenth aspects, process 800 includes transmitting an indication of a preferred EH class to use for the 2-step RACH procedure.

In a fifteenth aspect, alone or in combination with one or more of the first through fourteenth aspects, a parameter of the EH class includes a time gap between two RAR windows.

In a sixteenth aspect, alone or in combination with one or more of the first through fifteenth aspects, a parameter of the EH class includes a quantity of RAR windows.

In a seventeenth aspect, alone or in combination with one or more of the first through sixteenth aspects, performing the 2-step RACH procedure includes selecting, after transmitting a MsgA, one or more RAR windows in which to monitor for a MsgB, based at least in part on an EH state of the UE, and terminating the 2-step RACH procedure, independently of an EH state of the UE after transmitting the MsgA, in response to receiving an uplink grant addressed to an RNTI of the UE in an RAR window.

In an eighteenth aspect, alone or in combination with one or more of the first through seventeenth aspects, process 800 includes transmitting, in a Msg3 in response to receiving a fallback RAR, an indication of when the UE is able to monitor for a Msg4.

In a nineteenth aspect, alone or in combination with one or more of the first through eighteenth aspects, process 800 includes transmitting another MsgA in response to not having a sufficient amount of energy to complete the 2-step RACH procedure and after harvesting energy to transmit the other MsgA.

In a twentieth aspect, alone or in combination with one or more of the first through nineteenth aspects, process 800 includes selecting a new EH class before transmitting the other MsgA, where the other MsgA includes an indication of the new EH class.

In a twenty-first aspect, alone or in combination with one or more of the first through twentieth aspects, process 800 includes, in response to not having a sufficient amount of energy to transmit a MsgA payload, monitoring for a fallback RAR.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110, network entity 610) performs operations associated with RACH procedure based on an EH class.

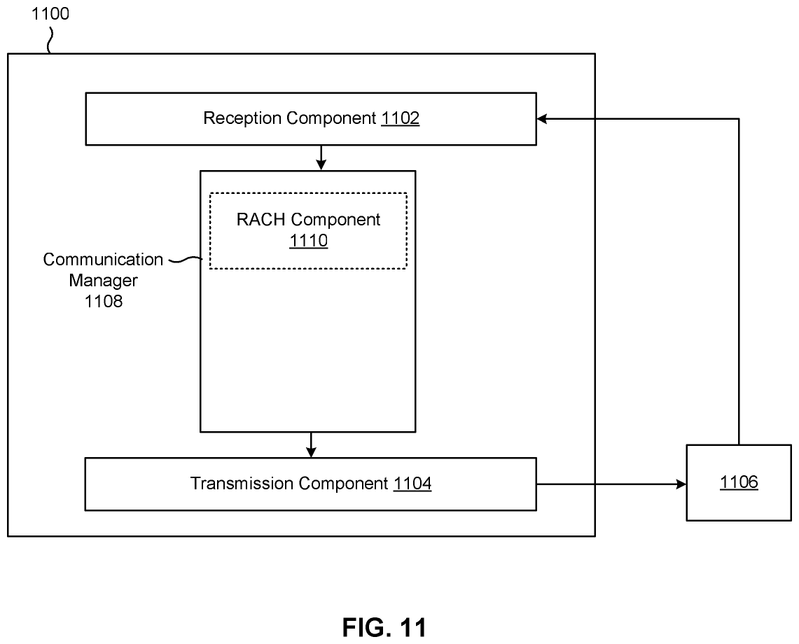

As shown in FIG. 9, in some aspects, process 900 may include transmitting configuration information that includes parameters associated with multiple EH classes (block 910). For example, the network entity (e.g., using communication manager 1108 and/or transmission component 1104 depicted in FIG. 11) may transmit configuration information that includes parameters associated with multiple EH classes, as described above.

As further shown in FIG. 9, in some aspects, process 900 may include receiving an indication of an EH class that is selected by a UE (block 920). For example, the network entity (e.g., using communication manager 1108 and/or reception component 1102 depicted in FIG. 11) may receive an indication of an EH class that is selected by a UE, as described above.

As further shown in FIG. 9, in some aspects, process 900 may include performing a 2-step RACH procedure with the UE based at least in part on the EH class (block 930). For example, the network entity (e.g., using communication manager 1108 and/or RACH component 1110 depicted in FIG. 11) may perform a 2-step RACH procedure with the UE based at least in part on the EH class, as described above.

Process 900 may include additional aspects, such as any single aspect or any combination of aspects described below and/or in connection with one or more other processes described elsewhere herein.

In a first aspect, a parameter associated with the EH class includes a maximum duty cycle that the UE is capable of supporting during the RACH procedure, a minimum amount of energy that is required for the UE at a start of the 2-step RACH procedure, or a minimum quantity of RACH attempts that can be performed by the UE without harvesting more energy.

In a second aspect, alone or in combination with the first aspect, a parameter associated with the EH class includes a minimum EH rate or a capability of the UE to ensure that the UE will have a sufficient amount of energy to finish the 2-step RACH procedure.

In a third aspect, alone or in combination with one or more of the first and second aspects, a parameter associated with the EH class includes a first time gap between the UE transmitting a MsgA preamble and transmitting a MsgA payload, a second time gap between the UE performing a measurement and transmitting a MsgA, or a third time gap between transmitting a MsgA and monitoring for a MsgB.

In a fourth aspect, alone or in combination with one or more of the first through third aspects, process 900 includes receiving an indication of the first time gap, the second time gap, the third time gap, or a preferred EH class for the UE to use for the 2-step RACH procedure in a MAC CE of the MsgA payload.

In a fifth aspect, alone or in combination with one or more of the first through fourth aspects, a parameter of the EH class includes a time gap between two RAR windows or a quantity of RAR windows, and performing the 2-step RACH procedure includes transmitting a MsgB in an RAR based at least in part on the time gap between two RAR windows or the quantity of RAR windows.

In a sixth aspect, alone or in combination with one or more of the first through fifth aspects, process 900 includes receiving, in a Msg3, an indication of when the UE is able to monitor for a Msg4, and transmitting the Msg4 based at least in part on the indication.

In a seventh aspect, alone or in combination with one or more of the first through sixth aspects, process 900 includes receiving, before the 2-step RACH procedure is completed, another MsgA that indicates a new EH class selected by the UE, and performing another 2-step RACH procedure based at least in part on the new EH class.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE (e.g., a UE 120, UE 620), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, a network entity, a charging device, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the UE described in connection with FIG. 2. The communication manager 1008 may be, or be similar to, the communication manager 140 depicted in FIGS. 1 and 2. For example, in some aspects, the communication manager 1008 may be configured to perform one or more of the functions described as being performed by the communication manager 140. In some aspects, the communication manager 1008 may include the reception component 1002 and/or the transmission component 1004. The communication manager 140 may include one or more of a selection component 1010, a RACH component 1012, and/or an EH component 1014, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive configuration information that includes parameters associated with multiple EH classes. The selection component 1010 may select an EH class, from among the multiple EH classes, based at least in part on the configuration information and an EH state of the UE. The RACH component 1012 may perform a 2-step RACH procedure based at least in part on the EH class. The EH component 1014 may harvest energy during the 2-step RACH procedure.

The transmission component 1004 may transmit an indication of the time gap in the MsgA. The transmission component 1004 may transmit an indication of a preferred EH class to use for the 2-step RACH procedure. The transmission component 1004 may transmit, in a Msg3 in response to receiving a fallback RAR, an indication of when the UE is able to monitor for a Msg4.

The transmission component 1004 may transmit another MsgA in response to not having a sufficient amount of energy to complete the 2-step RACH procedure and after harvesting energy to transmit the other MsgA. The selection component 1010 may select a new EH class before transmitting the other MsgA, where the other MsgA includes an indication of the new EH class.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity (e.g., base station 110, network entity 610), or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, a network entity, a charging device, or another wireless communication device) using the reception component 1102 and the transmission component 1104. As further shown, the apparatus 1100 may include the communication manager 1108. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the network entity described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 150. In some aspects, the communication manager 1108 may include the reception component 1102 and/or the transmission component 1104. The communication manager 1108 may include one or more of a RACH component 1110, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit configuration information that includes parameters associated with multiple EH classes. The reception component 1102 may receive an indication of an EH class that is selected by a UE. The RACH component 1110 may perform a 2-step RACH procedure with the UE based at least in part on the EH class.

The reception component 1102 may receive an indication of a first time gap, a second time gap, a third time gap, or a preferred EH class for the UE to use for the 2-step RACH procedure in a MAC CE of the MsgA payload. The reception component 1102 may receive, in a Msg3, an indication of when the UE is able to monitor for a Msg4.

The transmission component 1104 may transmit the Msg4 based at least in part on the indication. The reception component 1102 may receive, before the 2-step RACH procedure is completed, another MsgA that indicates a new EH class selected by the UE. The RACH component 1110 may perform another 2-step RACH procedure based at least in part on the new EH class.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configuration information that includes parameters associated with multiple energy harvesting (EH) classes; selecting an EH class, from among the multiple EH classes, based at least in part on the configuration information and an EH state of the UE; and performing a 2-step random access channel (RACH) procedure based at least in part on the EH class.

Aspect 2: The method of Aspect 1, wherein performing the 2-step RACH procedure includes transmitting an indication of the EH class in a MsgA payload.

Aspect 3: The method of Aspect 1 or 2, wherein a parameter associated with the EH class includes a maximum duty cycle that can be supported during the RACH procedure.

Aspect 4: The method of any of Aspects 1-3, wherein a parameter associated with the EH class includes a RACH resource or a RACH parameter.

Aspect 5: The method of any of Aspects 1-4, wherein a parameter associated with the EH class includes one or more of a physical RACH (PRACH) preamble set, a quantity of PRACH occasions, or a periodicity of PRACH occasions.

Aspect 6: The method of any of Aspects 1-5, wherein a parameter associated with the EH class includes a minimum amount of energy that is required at a start of the 2-step RACH procedure.

Aspect 7: The method of any of Aspects 1-6, further comprising harvesting energy during the 2-step RACH procedure.

Aspect 8: The method of any of Aspects 1-7, wherein a parameter associated with the EH class includes a quantity of RACH attempts that can be performed without harvesting more energy.

Aspect 9: The method of any of Aspects 1-8, wherein a parameter associated with the EH class includes a capability of the UE to ensure that the UE will have a sufficient amount of energy to finish the 2-step RACH procedure.

Aspect 10: The method of any of Aspects 1-9, wherein a parameter associated with the EH class includes a minimum EH rate.

Aspect 11: The method of any of Aspects 1-10, wherein a parameter associated with the EH class includes a time gap between transmitting a MsgA preamble and transmitting a MsgA payload.

Aspect 12: The method of any of Aspects 1-11, wherein a parameter associated with the EH class includes a time gap between performing a measurement and transmitting a MsgA.

Aspect 13: The method of any of Aspects 1-12, wherein a parameter associated with the EH class includes a time gap between transmitting a MsgA and monitoring for a MsgB.

Aspect 14: The method of Aspect 13, further comprising transmitting an indication of the time gap in the MsgA.

Aspect 15: The method of any of Aspects 1-14, further comprising transmitting an indication of a preferred EH class to use for the 2-step RACH procedure.

Aspect 16: The method of any of Aspects 1 and 3-13, further comprising, in response to not having a sufficient amount of energy to transmit a MsgA payload, monitoring for a fallback random access response (RAR).

Aspect 17: The method of any of Aspects 1-116, wherein a parameter of the EH class includes a time gap between two random access response windows.

Aspect 18: The method of any of Aspects 1-17, wherein a parameter of the EH class includes a quantity of random access response windows.

Aspect 19: The method of any of Aspects 1-15 and 17-18, wherein performing the 2-step RACH procedure includes: selecting, after transmitting a MsgA, one or more random access response (RAR) windows in which to monitor for a MsgB, based at least in part on an EH state of the UE; and terminating the 2-step RACH procedure, independently of an EH state of the UE after transmitting the MsgA, in response to receiving an uplink grant addressed to a radio network temporary identifier of the UE in an RAR window.

Aspect 20: The method of any of Aspects 1-19, further comprising transmitting, in a Msg3 in response to receiving a fallback random access response, an indication of when the UE is able to monitor for a Msg4.

Aspect 21: The method of any of Aspects 1, 3-13, and 15-18, further comprising transmitting another MsgA in response to not having a sufficient amount of energy to complete the 2-step RACH procedure and after harvesting energy to transmit the other MsgA.

Aspect 22: The method of Aspect 21, further comprising selecting a new EH class before transmitting the other MsgA, wherein the other MsgA includes an indication of the new EH class.

Aspect 23: A method of wireless communication performed by a network entity, comprising: transmitting configuration information that includes parameters associated with multiple energy harvesting (EH) classes; receiving an indication of an EH class that is selected by a user equipment (UE); and performing a 2-step random access channel (RACH) procedure with the UE based at least in part on the EH class.

Aspect 24: The method of Aspect 23, wherein a parameter associated with the EH class includes a maximum duty cycle that the UE is capable of supporting during the RACH procedure, a minimum amount of energy that is required for the UE at a start of the 2-step RACH procedure, or a minimum quantity of RACH attempts that can be performed by the UE without harvesting more energy.

Aspect 25: The method of Aspect 23 or 24, wherein a parameter associated with the EH class includes a minimum EH rate or a capability of the UE to ensure that the UE will have a sufficient amount of energy to finish the 2-step RACH procedure.

Aspect 26: The method of any of Aspects 23-25, wherein a parameter associated with the EH class includes a first time gap between the UE transmitting a MsgA preamble and transmitting a MsgA payload, a second time gap between the UE performing a measurement and transmitting a MsgA, or a third time gap between transmitting a MsgA and monitoring for a MsgB.

Aspect 27: The method of Aspect 26, further comprising receiving an indication of the first time gap, the second time gap, the third time gap, or a preferred EH class for the UE to use for the 2-step RACH procedure in a medium access control control element (MAC CE) of the MsgA payload.

Aspect 28: The method of any of Aspects 23-27, wherein a parameter of the EH class includes a time gap between two random access response (RAR) windows or a quantity of RAR windows, and wherein performing the 2-step RACH procedure includes transmitting a MsgB in an RAR based at least in part on the time gap between two RAR windows or the quantity of RAR windows.

Aspect 29: The method of any of Aspects 23-28, further comprising: receiving, in a Msg3, an indication of when the UE is able to monitor for a Msg4; and transmitting the Msg4 based at least in part on the indication.

Aspect 30: The method of any of Aspects 23-29, further comprising: receiving, before the 2-step RACH procedure is completed, another MsgA that indicates a new EH class selected by the UE; and performing another 2-step RACH procedure based at least in part on the new EH class.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive configuration information that includes parameters associated with multiple energy harvesting (EH) classes;
select an EH class, from among the multiple EH classes, based at least in part on the configuration information and an EH state of the UE; and
perform a 2-step random access channel (RACH) procedure based at least in part on the EH class.

2. The UE of claim 1, wherein the one or more processors, to perform the 2-step RACH procedure, are configured to transmit an indication of the EH class in a MsgA payload.

3. The UE of claim 1, wherein a parameter associated with the EH class includes a maximum duty cycle that can be supported during the RACH procedure.

4. The UE of claim 1, wherein a parameter associated with the EH class includes a RACH resource or a RACH parameter.

5. The UE of claim 1, wherein a parameter associated with the EH class includes one or more of a physical RACH (PRACH) preamble set, a quantity of PRACH occasions, or a periodicity of PRACH occasions.

6. The UE of claim 1, wherein a parameter associated with the EH class includes a minimum amount of energy that is required at a start of the 2-step RACH procedure.

7. The UE of claim 1, wherein the one or more processors are configured to harvest energy during the 2-step RACH procedure.

8. The UE of claim 1, wherein a parameter associated with the EH class includes a quantity of RACH attempts that can be performed without harvesting more energy.

9. The UE of claim 1, wherein a parameter associated with the EH class includes a capability of the UE to ensure that the UE will have a sufficient amount of energy to finish the 2-step RACH procedure.

10. The UE of claim 1, wherein a parameter associated with the EH class includes a minimum EH rate.

11. The UE of claim 1, wherein a parameter associated with the EH class includes a time gap between transmitting a MsgA preamble and transmitting a MsgA payload.

12. The UE of claim 1, wherein a parameter associated with the EH class includes a time gap between performing a measurement and transmitting a MsgA.

13. The UE of claim 1, wherein a parameter associated with the EH class includes a time gap between transmitting a MsgA and monitoring for a MsgB.

14. The UE of claim 13, wherein the one or more processors are configured to transmit an indication of the time gap in the MsgA.

15. The UE of claim 1, wherein the one or more processors are configured to transmit an indication of a preferred EH class to use for the 2-step RACH procedure.

16. The UE of claim 1, wherein the one or more processors are configured to, in response to not having a sufficient amount of energy to transmit a MsgA payload, monitor for a fallback random access response (RAR).

17. The UE of claim 1, wherein a parameter of the EH class includes a time gap between two random access response windows.

18. The UE of claim 1, wherein a parameter of the EH class includes a quantity of random access response windows.

19. The UE of claim 1, wherein the one or more processors, to perform the 2-step RACH procedure, are configured to:
select, after transmitting a MsgA, one or more random access response (RAR) windows in which to monitor for a MsgB, based at least in part on an EH state of the UE; and
terminate the 2-step RACH procedure, independently of an EH state of the UE after transmitting the MsgA, in response to reception of an uplink grant addressed to a radio network temporary identifier of the UE in an RAR window.

20. The UE of claim 1, wherein the one or more processors are configured to transmit, in a Msg3 in response to receiving a fallback random access response, an indication of when the UE is able to monitor for a Msg4.

21. The UE of claim 1, wherein the one or more processors are configured to transmit another MsgA in response to not having a sufficient amount of energy to complete the 2-step RACH procedure and after harvesting energy to transmit the other MsgA.

22. The UE of claim 21, wherein the one or more processors are configured to select a new EH class before transmitting the other MsgA, wherein the other MsgA includes an indication of the new EH class.

23. A network entity for wireless communication, comprising:
a memory; and
one or more processors, coupled to the memory, configured to:
transmit configuration information that includes parameters associated with multiple energy harvesting (EH) classes;
receive an indication of an EH class that is selected by a user equipment (UE); and
perform a 2-step random access channel (RACH) procedure with the UE based at least in part on the EH class.

24. The network entity of claim 23, wherein a parameter associated with the EH class includes a maximum duty cycle that the UE is capable of supporting during the RACH procedure, a minimum amount of energy that is required for the UE at a start of the 2-step RACH procedure, or a minimum quantity of RACH attempts that can be performed by the UE without harvesting more energy.

25. The network entity of claim 23, wherein a parameter associated with the EH class includes a minimum EH rate or a capability of the UE to ensure that the UE will have a sufficient amount of energy to finish the 2-step RACH procedure.

26. The network entity of claim 23, wherein a parameter associated with the EH class includes a first time gap between the UE transmitting a MsgA preamble and transmitting a MsgA payload, a second time gap between the UE performing a measurement and transmitting a MsgA, or a third time gap between transmitting a MsgA and monitoring for a MsgB.

27. The network entity of claim 26, wherein the one or more processors are configured to receive an indication of the first time gap, the second time gap, the third time gap, or a preferred EH class for the UE to use for the 2-step RACH procedure in a medium access control control element (MAC CE) of the MsgA payload.

28. The network entity of claim 23, wherein a parameter of the EH class includes a time gap between two random access response (RAR) windows or a quantity of RAR windows, and wherein the one or more processors, to perform the 2-step RACH procedure, are configured to transmit a MsgB in an RAR based at least in part on the time gap between two RAR windows or the quantity of RAR windows.

29. The network entity of claim 23, wherein the one or more processors are configured to:
receive, in a Msg3, an indication of when the UE is able to monitor for a Msg4; and
transmit the Msg4 based at least in part on the indication.

30. The network entity of claim 23, wherein the one or more processors are configured to:
receive, before the 2-step RACH procedure is completed, another MsgA that indicates a new EH class selected by the UE; and
perform another 2-step RACH procedure based at least in part on the new EH class.
